(19) United States
(12) Patent Application Publication
(10) Pub. No.: US 2012/0273492 A1
(43) Pub. Date: Nov. 1, 2012

(54) Ergonomic Stay-On Tab

(75) Inventors: Elmer D. Werth, Longmont, CO (US); Jeffrey J. Meinerz, Denver, CO (US)

(73) Assignees: Jeffrey J. Meinerz, Denver, CO (US); Elmer D. Werth, Longmont, CO (US)

(21) Appl. No.: 13/094,558

(22) Filed: Apr. 26, 2011

(51) Int. Cl. B65D 17/50; B31B 1/26

(52) U.S. Cl. 220/260; 493/405

(57) ABSTRACT

A stay-on opening tab has a nose portion extending from one side of an attaching rivet and a lifting lever extending from the opposite side of the rivet. The lifting end of the tab is contoured in a simple or compound curve at the lifting end, creating a concave fingertip entry gap at the lifting end. The concavity may be a simple U-shape or it may be additionally arched. The tab may be longitudinally arched for substantially its entire longitudinal dimension, thereby also providing shape strengthening for improved beam strength. Where the nose is arched, the tab operates with smoothly guided pivotal action.

### BACKGROUND OF THE INVENTION

1. Field of the Invention

The invention generally relates to closures and to closure opening arrangements, such as opening devices. More specifically, the invention relates to a closure having a frangible member about a line or point of weakness, where the member is nonremovable, and where a gripping means, such as a pull tab or other opener, is attached to or integral with the member.

2. Description of Related Art Including Information Disclosed Under 37 CFR 1.97 and 1.98

Pressurized beverage containers include self-opening devices on the top end panel. A typical self-opening device consists of an opening area of the end panel largely circumscribed by a frangible line, leaving a minor, non-circumscribed portion of the opening area connected directly to the remainder of the end panel. The non-circumscribed connection is referred to as the hinge. When sharp pressure is applied to the circumscribed opening area, the frangible line fractures, leaving the opening area attached to the end panel by only the hinge. The opening area can then be bent on the hinge to open the container, creating a resultant opening large enough for drinking or pouring the contents. The opening area is sometimes known as a press tab. Variations in the size of the opening area are considerable. Some containers, usually food cans, may have the majority of the end panel circumscribed by a frangible line near the perimeter of the end panel, with no hinge, such that substantially the entire end of the container is removable by tearing or fracturing the frangible line.

A self-opening device further provides a pivot lever that is attached to the end panel by a rivet that also serves as a fulcrum. The pivot level is positioned above the top of the end panel so that when a first end is raised, the opposite end presses against the opening area and fractures the frangible line. Further raising the first end causes the second, opposite end to rock downward on the fulcrum and thereby depress the opening area on the hinge, creating a large access opening in the end panel. The pivot lever is variously known as a stay-on tab or pull tab. Variations of the pivot lever are used on food cans to start a fracture of the frangible line, after which lifting the pivot lever also pulls up the removable portion of the end panel and tears the remainder of the frangible line. Self-opening devices are desirable because the stay-on tab remains together with a larger portion of the container, whether that portion is the remaining entirety of the container or merely a large fraction of the torn-away lid. In either event, the relatively small stay-on tab tends to be properly disposed of, in combination with its attached portion of the container or end panel.

A problem in the art is that the stay-on tab can be difficult to lift. Gaining finger access under the first end of the stay-on tab is an initial challenge. The tab is riveted to the end panel, which creates a stiff, close mounting. Such a close mounting is needed and desired because the containers are designed to stack, requiring that the base of an upper container can nest in the top of a lower container. A further complicating feature is that the stay-on tab must have sufficient beam strength such that it is not easily bent, so that it can fracture the frangible line when lifted. Thus, the stay-on tab is stiff, strong, and closely positioned to the top end panel, creating a problem for many persons to access and lift the stay-on tab to open the container.

Various tab and container end designs have attempted to solve this problem, but the problem persists. As examples, U.S. Patent Application Publication 2006/0196875 to Cherian suggests a tab with lifting end bent up, with a recess in the end panel below the lifting end of the stay-on tab, and with ramped spacers for holding the lifting end of the tab at a spacing from the end panel. U.S. Pat. No. 6,138,856 to Ghim et al. shows an end panel configured to define a recess under the lifting end of the stay-on tab. These suggested solutions require expensive modifications to manufacturing tooling, and the operation of the resulting opening devices is not always clear to the consumer.

It would be desirable to provide an end closure with a stay-on tab that could be readily accessed and lifted, in a design that did not interfere with the stackability of the containers.

To achieve the foregoing and other objects and in accordance with the purpose of the present invention, as embodied and broadly described herein, the method and apparatus of this invention may comprise the following.

### BRIEF SUMMARY OF THE INVENTION

Against the described background, it is therefore a general object of the invention to provide improved finger engagement with the lever end of a stay-on tab.

The invention is a can end structure having an opening tab or opening ring that is arranged for improved access by the user's fingertip. As with conventional opening tab structure, the tab is riveted to the end panel of the can, with a nose portion of a first end extending distally beyond the rivet to serve as an opening lever. A lifting lever extends proximally from the rivet. The user must lift the lifting lever at the second, lifting end of the tab to tilt the tab across the rivet as a fulcrum. As the user raises the lifting lever, the extending nose of the first end is forced down against an opening panel, separating a parting line at the margins of the panel and pushing the panel down. The lifting end of the tab is contoured in a simple or compound curve at the lifting end, creating a cavern-like fingertip entry gap at the lifting end.

The improvement is the creation of extra space between the end panel and the lifting end of the tab. Various modifications achieve this result. In one modification, the lifting end of the tab is contoured with an upward curve near the center of the lifting end, creating the cavern-like fingertip entry gap at the lifting end. In a second modification, the typical gripping portion of the tab can be reduced to a concavity so that it is configured as U-shaped. The fingertip is inserted into the open side of the U-shaped lifting portion. In a third modification, elevation walls and spacers lift and support the lifting end of the tab at a suitable separation from the end panel, creating a finger entry gap at the second end. The spacers can be upraised from the end panel or depend from the bottom of the tab.

According to the invention, a longitudinally disposed stay-on opening tab is adapted for mounting on a container having an opening panel at least partially defined by a parting line. A distal end of the tab is a container opening nose. A proximal end of the tab is a lifting lever. A fastener attachment structure is intermediate the container opening nose and lifting lever. The lifting lever defines a proximal end edge that is configured as a concavity and sized to at least partially receive a user's fingertip.

According to another aspect of the invention, a container lid is formed of a lid body with a parting line that at least partially defines an openable panel in the lid body. A fastener is positioned on the lid body in predefined proximity to the openable panel for attaching a stay-on tab at a suitable location for selective operation to separate the parting line. A stay-on opening tab is formed of a container opening nose at a distal end of the tab, a lifting lever at a proximal end of the tab; and a fastener attachment structure intermediate the container opening nose end and lifting lever. The lifting lever defines a proximal end edge configured as a concavity and sized to at least partially receive a user's fingertip.

According to still another aspect of the invention, a container is formed of a container wall with a parting line that at least partially defines an openable panel in the container wall. A fastener is positioned on the container wall in predefined proximity to the openable panel and attaches a stay-on tab in a suitable location for selective operation to separate the parting line. The stay-on tab is formed of a distal end portion that lies generally along a first plane near the container wall. A proximal end portion of the tab defines a proximal end edge that is configured as a concavity and is sized to receive at least a portion of a user's fingertip therein. A fastener attachment structure is engaged with the fastener and attaches the tab to the container wall in predefined proximity to the openable panel for selectively operation to separate the parting line.

The accompanying drawings, which are incorporated in and form a part of the specification, illustrate preferred embodiments of the present invention, and together with the description, serve to explain the principles of the invention. In the drawings:

### BRIEF DESCRIPTION OF THE SEVERAL VIEWS OF THE DRAWINGS

FIG. 1 is a top plan view of a container lid of the food can style, with majority of the lid being removable, showing the new stay-on tab.

FIG. 2 is a vertical cross-sectional view taken along the plane of line 2-2 in FIG. 1.

FIG. 3 is a top plan view of a container lid of the beverage can style, with hinged opening area, showing the new tab.

FIG. 4 is a vertical cross-sectional view taken along the plane of line 4-4 in FIG. 3.

FIG. 5 is an isometric view of the new stay-on tab of the food can style.

FIG. 6 is an isometric view of the new stay-on tab of the beverage can style configured with an arched end.

FIG. 7 is an isometric view of the new stay-on tab configured with a full length arch.

FIG. 8 is a cross-sectional view taken along the plane of line 8-8 in FIG. 7.

FIG. 9 is a top plan view showing comparative areas of a blank for forming a stay-on tab of the beverage can style and a blank for forming a present day commercial stay-on tab of the beverage can style.

FIG. 10 is a top plan view of sheet stock with a proposed cutting pattern of blanks for forming beverage can style tabs, showing hypothetical comparative scrap areas between sheet stock cut into blanks for the stay-on tab of FIG. 9 and for a present day commercial stay-on tab of the beverage can style, arranged in either of two forming patterns.

FIG. 11 is a view similar to FIG. 9, as applied to a blank for a food can style tab.

FIG. 12 is a top plan view showing sheet stock with a proposed cutting pattern of blanks for forming food can style tabs.

### DETAILED DESCRIPTION OF THE INVENTION

The invention is an improved, ergonomic opening tab for a container. In a further aspect, the invention is a container lid having an improved, ergonomic, stay-on opening tab positioned to actuate an opening panel in the lid. In another aspect, the invention is a container having an improved, ergonomic, stay-on opening tab positioned to actuate an opening panel at a preselected location on the container.

The tab is configured to provide two major tab portions. Optionally, the two tab portions are generally disposed along separate planes, at different elevations, or on different levels with an offset wall interconnecting the two tab portions. The two major tab portions are, first, an opener or pressing lever at a first level and, second, a lifter or gripping portion that is optionally at least partially on a second level, offset above the first portion at the first level. The first level is approximately juxtaposed to an underlying surface of the container body or container lid, when the tab is attached to the container. The second level, where optionally employed, is offset to a greater distance from the underlying surface of the container body or container lid, when the tab is attached to the container.

The first tab portion extends from a distal end to a mounting structure such as an opening for receiving a rivet or other fastener attaching the tab to a container. The second tab portion extends from the mounting point to a proximal end for gripping engagement by a user to employ the tab for opening the container. At least a portion of the gripping means is positioned at an upward or more distant offset from the level of the opening lever and from an underlying opening panel of a container surface and is contoured with a concave reception face for receiving a user's fingertip. This invention is an improvement in openable can ends for food and beverage cans that employ stay-on tabs or pull tabs for separating the opening portion from the remainder of a container lid.

The container itself and the lid, in particular, typically are formed from sheet material such as sheet metal. Such sheet material enables an opening panel to be defined by a frangible or separable parting line at a selected location on the container, most commonly on the container lid. The parting line can be established by scoring, coining, or any other process. The parting line is configured in a desired contour at a desired location, whether on the container lid, container bottom, container sidewall, or elsewhere. The invention is applied to such containers, where most typically the parting line is established on the lid or closure. For purposes of description and not as a limitation, the invention will be described as being applied to the lid of a container, which is a typical commercial application of a stay-on opening tab.

Thus, most typically the lid or closure, or an openable portion of the lid or closure, is constructed to be ruptured, fractured, or cut away in order to gain access to the receptacle contents. The rupture, fracture, or cut is located at a predetermined line or point of weakness. The stay-on tab or pull tab includes a means for the user to grip the stay-on tab or pull tab. The gripping means is integral with or attached to the stay-on tab. The stay-on tab is connected to the container in such a way that the tab can tilt on a fulcrum to separate the parting line and thereby open the container. Depending on the design of the container, the tab can be tilted beyond the necessary degree to separate the parting line. This additional tilting of the tab may be effective to depress the opening panel into the container to improve access at the opening, or with certain styles of tabs and parting lines, the gripping portion may be pulled upwardly to rip the opening panel away from the remainder of the container.

For convenience of description, the term, “parting line” will be used throughout this description to describe the predetermined line of weakness, regardless of how the line of weakness was established. The term, “separate” will be used to describe the process of causing the parting line to open, regardless of what technique is used to achieve or enlarge the opening. The new tab will be described in two primary embodiments. One is similar to commercial tabs found on food cans, and the second is similar to commercial tabs found on beverage cans. While the two embodiments will be described as having certain differences in size and details of construction, the inventive features are applied to both. Therefore, the description of inventive features for either embodiment is equally applicable to the other unless specifically stated to be otherwise. The same numbering will be used to identify the same elements in either style of tab.

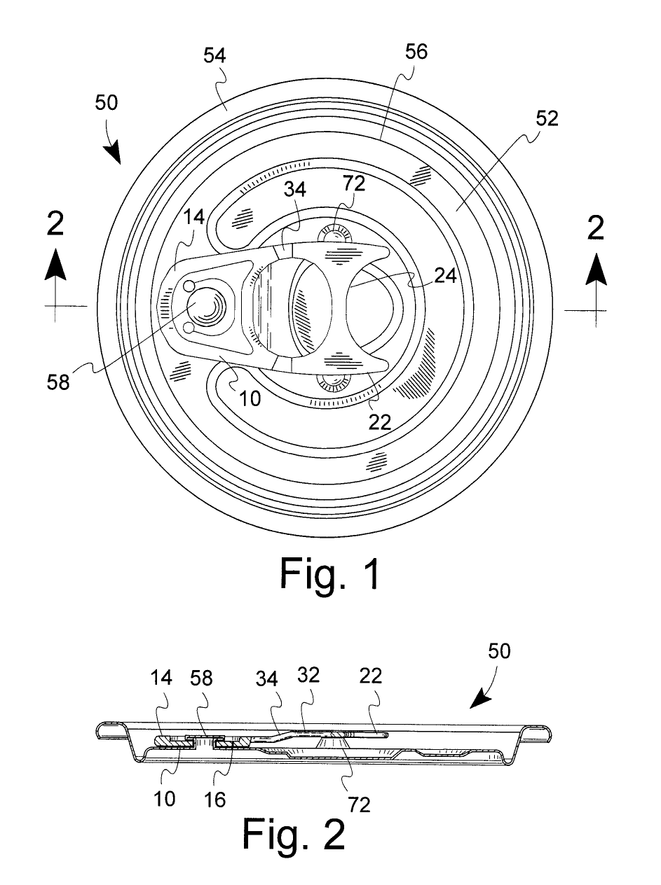

FIGS. 1, 2, and 5 best show the embodiment of the new stay-on tab 10 that is similar to a commercial tab used on food cans. A food can tab tends to be larger than a beverage can tab. In addition, a food can usually has a parting line near the periphery of the lid, which leads to the tab being mounted offset from the center point of the lid, near the peripheral parting line as best shown in FIGS. 1 and 2.

Tab 10 is formed in one piece, although it would be possible to employ multiple component pieces joined together as required for strength and functionality. The tab 10 can be formed of metal, such as aluminum or steel. Areas of the tab may be cut away as found practical to reduce the amount of metal in the tab structure. Portions of the tab may be formed of multiple layers of metal, and edges may be turned over or under to provide beam strength as required and to eliminate exposure to sharp edges.

The tab 10 is designed to be mounted on a container. For this purpose, the tab includes a fastener attachment structure 12. An efficient mounting method is by riveting the tab to the container at a preselected location such that the tab will be properly located to open a predefined opening panel. The rivet 58 is integral with the container, most commonly with the lid 50 of the container. Tab 10 may provide a fastener attachment structure that is specifically for receiving the rivet 58. A suitable structure is a hole 12. An integral rivet 58 can be formed in the container lid in a preliminary cylindrical shape that can be inserted through the hole 12. Once the rivet has been inserted, the portion extending beyond the tab can be flattened to create a rivet 58 with head that is larger than hole 12. The rivet head holds a local portion 18 of the tab in juxtaposed position against the underlying surface of the container. At least the local portion 18 of tab 10 under the rivet head remains in such a juxtaposed position.

Portions of tab 10 provide at least two functions that are distinctly identifiable, although interrelated. It is useful to refer to separate physical sub-portions of the tab 10 that chiefly perform each function. The division of the tab into such physical sub-portions is inexact because the tab is typically a unitary structure and has no sharp dividing line between sections performing each function. Therefore, the sub-portions are identified primarily for purposes of description, with the understanding that the described functions may not be entirely localized as attributed in the description.

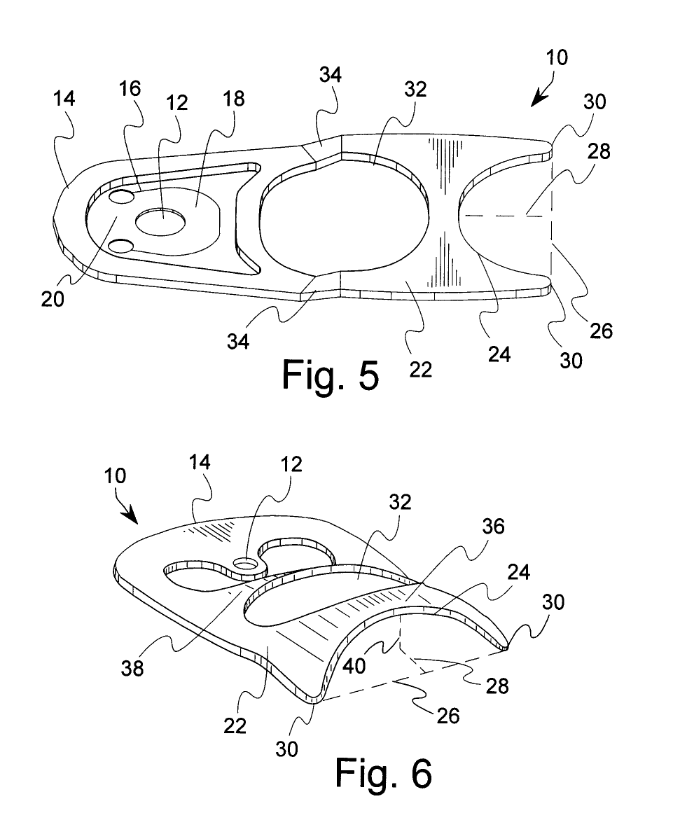

With the above understanding in mind, the fastener attachment structure 12 is selected for purposes of description as a division point or middle area between two functionally differentiated sub-portions at opposite longitudinal positions with respect to structure 12. In the view of FIG. 5, the tab is shown to be longitudinally disposed along a generally horizontal axis extending side-to-side in the figure. The left longitudinal end of the tab can be identified as the distal end, nose, or pressing end 14 of the tab, which functions by being pressed against the opening panel of a container to separate a parting line and thereby open the opening panel. This function requires that the nose 14 be tilted down against the opening panel, such as on or over a fulcrum, to press the nose against the opening panel with sufficient force to separate the parting line.

The rivet or other fastener at hole 12 serves as the fulcrum. When the right longitudinal end of tab 10, as viewed in FIG. 5, is lifted, the left end will drop due to the fulcrum action of the rivet head fastened over hole 12. A cut 16 is formed around the right-hand edge and sides of hole 12, at a suitable spacing from hole 12 to lie outside the rivet head. Cut 16 defines a hinge ear 18, which is retained against the container lid, under the rivet head. An uncut edge portion 20 of hinge ear 18 connects the hinge ear to the remainder of the tab and serves as a hinge when the tab is manipulated to open the container.

When the right end of tab 10 is lifted, the left end of tab 10 tends to pivot down from hinge 20 of sheet material at the non-severed, left end of hinge ear 18. Hinge 20 bends more readily than the rivet, such that nose 14 drops from hinge 20, efficiently transferring the lifting force applied to the right of the hole 12 to the dropping nose located at the left of hole 12 and the rivet.

Referring again to the view of FIG. 5, the right longitudinal portion of tab 10 is the proximal sub-portion, tail, or lifting lever 22 of tab 10, and functions by being lifted away from the opening panel of the container to downwardly tilt nose 14 against the opening panel, as described above, to thereby open the opening panel of the container. This function requires that the lifting lever 22 be tilted over a fulcrum, with sufficient force to cause nose 14 to press against the opening panel to separate the parting line.

Consumers face a difficulty in operating some stay-on tabs because it is difficult to raise the lifting lever of the known commercial tabs. This difficulty falls into two interrelated objections. One objection is that the commercial tab is inherently difficult to lift at a lifting lever simply because the opening panel of the commercial container requires considerable force to separate the parting line. The use of a longer lifting lever 22 would provide a solution, but the length of lifting lever 22 is limited by the size of the container and by the need to maintain enough space for finger access to the tail of the lifting lever. Some consumers fix the objection by using a pry bar such as a knife or screwdriver to lift the lifting lever 22.

The second objection is that the commercial tab is mounted too close to the underlying surface of the container, making it difficult and sometimes painful to initiate fingertip access under the lifting lever. Some consumers fix this objection by the same expedient of employing a pry bar that can be forced under the lifting lever to raise it.

Tab 10 resolves these problems by establishing a user-friendly, ergonomic, proximal edge 24 on lifting lever 22. According to the view of FIG. 5, the right end of tab 10 forms a concave edge 24. The concave contour of edge 24 may be a partial circle or smooth arc, or the edge may provide a different concave contour as found desirable. The concave end edge 24 defines an entry location for inserting a fingertip to grip the tab 10. The concave edge 24 is sized to receive a portion of a finger in the concavity. The shape and size of the concavity provides a broad line of contact with a broad portion of the user's fingertip in order to spread the pressure of lifting the proximal end of tab 10 over a substantial width of a typical or popular-sized fingertip. As compared to using a tab without this feature, the user experiences an improved degree of comfort when inserting a fingertip under lifting end 22 and thereafter raising end 22. This improved comfort enables the user to apply an increased raising force without experiencing discomfort. Thus, the design of lifting lever 22 improves both the act of inserting a fingertip and the act of lifting the tail of tab 10.

A user typically employs his thumb or index finger to open commercial stay-on tabs. Of course, the width of a human thumb or index fingertip can vary among different individuals. Expected variation occurs between males and females, persons of different ages, and persons of different sizes and weights. As a guideline for determining a suitable width to enable concave edge 24 to achieve an ergonomic result, a typical size for an index fingertip is about five-eighths of an inch wide, while the width of a thumb is about seven-eighths of an inch wide. These estimates of typical size are confirmed by numerous sources, both ancient and modern. Ancient measurements include a unit known as Etzba, or a thumb breadth, which has been estimated to be from 2-2.4 cm, or 0.79-0.94 inches. Some modern reports suggest that the width of a human male finger is about 2 cm, or 0.79 inches. A biomechanical study suggests that a human fingertip width is 16-20 mm, or 0.63-0.79 inches. These size estimations are useful in meaningfully referring to the size of a human finger and in formulating a contour for edge 24.

Considering variations among people's digits and considering that in many or most examples, the concave recess will receive a limited portion of the index fingertip, a minimum desired concavity is thought to be in a range from about three-eighths inch to about one-half inch. This measurement can be regarded as the width 26 across the mouth of the recess created by concave edge 24. Larger or wider fingertips or thumbs are accommodated by partial receipt into the cavity defined by edge 24. The depth of the cavity can be measured at a normal line or longitudinal axis from mouth opening 26 to the center point of edge 24, shown in FIG. 5 as longitudinal dimension line 28. A longitudinal depth 28 in the range from about twenty percent of width 26 to fifty percent of width 26 is believed to be suitable for providing an ergonomic result. The trailing corners 30 of the cavity are smoothly rounded for comfort, in the event that larger or wider digits are applied to the gripping end 22 of tab 10.

As an additional aid to users who employ a combination of thumb and index finger to open some stay-on tabs, the lifting lever 22 defines a counter-engagement hole 32 for receiving a user's finger. This finger hole 32 may be similar in width to recess 24, where allowed by the size of the tab.

FIGS. 1-6 show a further, optional improvement in the configuration of new tab. The proximal end 22 of tab 10 is at least partially disposed in an upwardly offset position, such that at least a portion of the proximal end 22 is elevated above the distal end to create a gap between end 24 and the underlying portion of the container. This gap enables improved finger access. In FIGS. 1-5, proximal end 22 includes elevation walls 34, each creating a dogleg structure that interconnects two different levels of tab 10. These walls 34 may be located at the illustrated positions, intermediate the fastener attachment structure 12 and edge 24.

The second, elevated level of tab 10 includes edge 24 and will be described as being the higher or upper plane because, in application, the level including edge 24 is spaced above the underlying container wall in the typical orientations shown in FIGS. 2 and 4. The proximal portion of tab 10 may include areas lying in both the upper plane and the lower plane. The walls 34 may have a resilient characteristic, allowing the raised tail 24 to be temporarily depressed, if required, such as if a stacked container depresses the elevated level of tab 10.

FIG. 6 shows another, optional variation in the upwardly offset configuration of proximal end 22. The proximal end 22 is centrally elevated, such that the center point of concave edge 24 is elevated above the opposite ends of edge 24. The elevation extends along the longitudinal axis of tab 10 with elevation decreasing toward attachment structure 12. The side edges of proximal end 22, which include corners 30, are the base of the arch and lie lower than the center 36. This structure will be referred to as a longitudinal arch due to the elevated portion of the arch generally lying along the longitudinal dimension of the tab at proximal end 22.

Where the tab employs a finger hole 32, a transverse bridge 36 is present between the finger hole 32 and edge 24. This transverse bridge 36 is the primary vertically arched structure of proximal end 22. A secondary transverse bridge 38 may be present between the finger hole 32 and fastener attachment hole 12. The secondary bridge may be slightly vertically arched as an initiating structure to the greater vertical arch of bridge 36. The bridges 36, 38 serve a purpose similar to elevation walls 34 by creating an upward offset over a central portion of edge 24, thereby creating a gap between the central portion of edge 24 and the underlying container surface. Elevation walls 34 are not necessary in the embodiment of FIG. 6.

The vertical, longitudinal arch along proximal end 22 stiffens the proximal end to better transmit lifting forces to the distal end for operating the opener. The vertical aspect of the arch also establishes an enlarged gap under the center of edge 24 for improved finger access. The tab of FIG. 6 can be viewed as resting on a horizontal plane. In this orientation, dimension lines in FIG. 6 show that edge 24 is a compound curve defined by a horizontal mouth width 26, a horizontal curve depth 28, and a vertical arch height 40. The height 40 may be selected according to the maximum space available in each application where tab 10 is employed. Corners 30 may be disposed in a resting position against an underlying surface of the container employing tab 10. Arch height 40 may be limited by space available when similar containers are stacked.

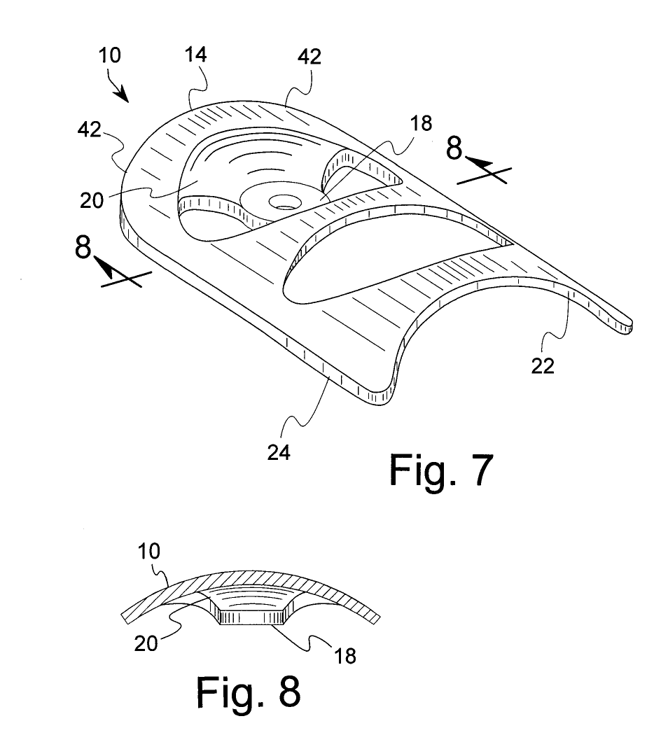

FIGS. 7 and 8 show another arched configuration of tab 10 in which both the nose 14 and tail 22 of the tab are arched and the side edges of the arch establish a base level, which might rest against an underlying container lid. The arch may be uniform from nose to tail, providing a strong longitudinal physical configuration that allows the tab to be fabricated from sheet stock of thinner gauge than otherwise possible. Nose 14 is both curved, as shown in FIG. 6, and centrally elevated. Curved side edges 42 of nose 14 extend from the center of the arch at nose 14 in a rearward and downward curve to the base level at each side edge.

Hinge ear 18 is below the center of the arch, approximately at the base level. When the hinge ear is riveted to a container lid, it will be held against the container lid at the rivet location and height, which sometimes can be slightly above or below the base level of the tab, depending upon the contours of the container lid. Hinge 20 extends between hinge ear 18 and the upper, arched portion of the tab near nose 14. Therefore, hinge 20 ties the center of the arch to the container lid at the rivet. The width of hinge 20, measured in degrees centered at the rivet hole, is one the order of one hundred twenty degrees or more, in order to provide control over the position of nose 14 when the tab is lifted. A range from one hundred degrees to one hundred eighty degrees as a width of hinge 20 is desirable to offset undue recession of nose 14.

When the tab 10 of FIGS. 7 and 8 is lifted at tail 22, the curved sides 42 of nose 14 provide a rolling action against the can lid. Hinge ear 18 remains located at the base level of the arch. Nose 14 pivots downward as the sides 42 of the nose provide smooth, gradual guidance.

The full length arch of FIG. 7 may be curved as a segment of a cylinder wall. A curvature of one-fourth to one-fifth of the circumference provides a strong tab. In FIG. 8, the tab is shown with an arc of curvature that is about seventy-five degrees.

Tab 10 is best employed on a container such as a can, which may be a metal can, and typically on the lid of such can. FIGS. 1-4 show greater detail of the opening systems applicable to beverage cans and food cans. A first arrangement is shown by the food can lid 50 in FIGS. 1 and 2 and may be referred to as a full opening system. Often the opening panel 52 has a diameter or cross-dimension that is nearly equal to the diameter or cross-dimension of the container lid body 54. The opening panel 52 is circumscribed or peripherally defined by a parting line 56. Often the parting line in a full opening system is a closed geometric figure, such that the opening panel can be entirely separated from the remainder of the lid body 54 when the parting line is fully separated. The diameter of the opening panel 52 is a major portion of the diameter of the lid body 54.

FIGS. 1 and 2 show an example of a food can and the tab suitable for use on such a food can. The diameter of the opening panel 52 is approximately at least eighty percent of the total diameter of lid body 54. The parting line 56 is located near the periphery of the lid 50. A fastener such as an integral rivet 58 attaches stay-on tab 10 to the lid. The fastener is located at a laterally offset position from the center of the lid body 54, placing the attachment for the tab near the parting line. Rivet 58 passes through mounting hole 12 in tab 10 and serves as a part of the fulcrum when the proximal end of tab 10 is lifted. Cut 16 is formed around the proximal edge and sides of the rivet and mounting hole location 12 so that the nose of tab 10 pivots down on the distal side of the rivet 58. This example illustrates how tab 10 is applied in a common commercial variety of a full opening system, often employed on food cans. It is not necessary that the diameter or cross-dimension of the full opening panel have any particular percentile relationship to the total diameter or cross-dimension of the lid 50.

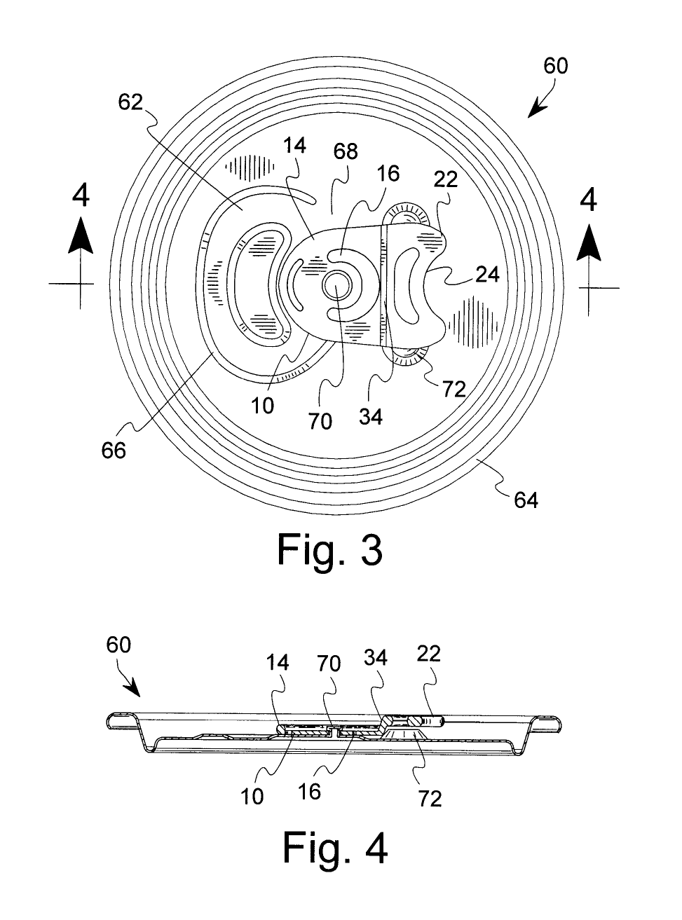

FIGS. 3 and 4 show an example of a beverage can and a tab suitable for use on such a beverage can. Lid 60 in FIGS. 3 and 4 and may be referred to as a partial opening system. A partial opening panel 62 has a cross-dimension that is less than one-half of the diameter or cross-dimension of the container lid body 64. The partial opening panel 62 is peripherally defined by a parting line 66 plus a hinge area 68 where the parting line is not present. Typically the parting line 66 in a partially opening system is an open geometric figure, such that the opening panel will not be entirely separated from the remainder of the container lid body 64 when the parting line is separated. Instead, a hinge area 68 will remain unseparated when the panel 62 is opened at the parting line.

In this example, FIG. 3 shows that the cross-dimension of the opening panel 62 is a minor portion of the diameter of the lid body 64. This relative sizing relationship is established by the practice of placing a fastener such as a central, integral rivet 70, which attaches stay-on tab 10 to the lid body 64, at or near the center of lid body 64, placing the attachment for the tab near parting line 66. The central rivet 70 passes through a mounting hole 12 in the tab 10 and serves as a part of the fulcrum when the proximal end of the tab is lifted. The cut 16 is formed around the proximal edge and sides of the rivet and mounting hole location 12 so that the tab 10 pivots on the distal side of the rivet. This example illustrates how tab 10 is applied in a common commercial variety of a partial opening system, often employed on pressurized beverage cans. Typically, the partial opening panel is disposed to one side of the central rivet 70, between the rivet and the periphery of the lid 60. It is not necessary that the cross-dimension of the partial opening panel have any particular dimensional relationship to the total cross-dimension of the lid.

In summary, an appropriately configured stay-on tab 10 can be mounted on a container in a suitable position to separate the parting line of an opening panel. In each of the described combinations of stay-on tab 10 with a container or container lid, the tab is configured to provide the user with improved finger access for lifting the gripping end of the tab in order to press the opposite, pressing nose against the opening panel 52, 62 at or near the parting line to separate the parting line.

In FIGS. 1 and 2, the tab 10 is configured to have a relatively shorter pressing end 14 located to one side of rivet 58. A relatively longer gripping end 22 is located on the opposite side of the rivet. The relatively longer length of the gripping end 22 provides a leverage advantage against the pressing end 14 when the gripping end is lifted.

In FIGS. 2 and 4, the stay-on tab is configured to create an offset spacing from the underlying container lid 50, 60 at the concave edge surface 24. In one example of a resulting profile, the tab can be referred to as having a dogleg structure. An upward angling wall portion 34 establishes a gap between the lid body 54, 64 and the concave edge 24. This gap provides a ready entry location for a portion of the user's fingertip. The dogleg wall portion 34 is located between the rivet 58, 70 and the edge 24. The underlying lid body 54, 64 may be configured with one or more upstanding spacers 72 positioned to support the upwardly offset portion of the gripping end. Where the tab 10 is arched, as disclosed in FIG. 6, the arch provides an alternative to spacers 72 in elevating a portion of concave edge 24.

Economic and pragmatic factors often limit the size of a stay-on tab. These might include a desire to limit material costs, a limited size of the actual container lid body, and a limited clearance available between the gripping end and the rim of the container lid body. These factors gravitate toward placing an upper limit on the size of a stay-on tab regardless of how large user's finger may be. Accordingly, expanding the width of the stay-on tab to enable the use of a concave recess to fully accommodate a large finger or thumb is unlikely to be done. A practical maximum width of the concave opening is thought to be near three-quarters of an inch, which might be used on appropriately large sized and styled container lids. As an example, it may be noted that the food can style of lid 50 allows more room for a larger stay-on tab, correspondingly allowing a larger opening to the concave recess. The beverage can style of lid 60 allows less room for the stay-on tab, favoring the use of a smaller opening to the concave recess.

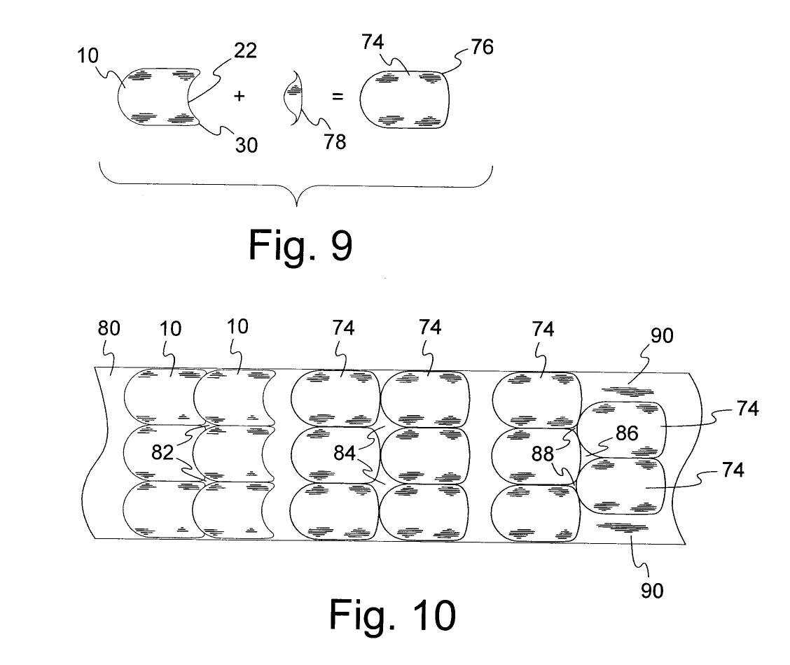

In addition to offering improved ergonomics, the stay-on tab 10 offers improved efficiency in material utilization due to the U-shaped configuration for finger engagement. Metal savings, or savings of most any other material that is utilized, can be estimated by comparing the tab in either of two ways. FIG. 9 shows an example of a first comparison, which may be referred to as shape savings. To determine shape savings of the example, the shape of beverage can style tab 10 is compared to the shape of a similar, conventional, commercial tab 74. The two tabs are presented in similar format, as blanks that show a peripheral outline without showing additional structures. In use, both would be further formed and configured. Tab 10 is presented as having the same width as commercial tab 74 and as having similar total length. Where tab 10 is concave at edge 22, the corners 30 extend to a similar overall length as corners 76 of commercial tab 74.

A remainder segment 78 represents a shape savings, which is the difference in area between tabs 10 and 74. Hence, FIG. 9 shows the tabs as elements of a formula wherein the area of tab 10 plus the area of remainder segment 78 equals the area of tab blank 74. The relative areas of the specific illustrated configurations in the example can be calculated, showing that the area of tab 10 is about eighty-four percent of the area of tab 74. Correspondingly, the shape savings represented by the area of remainder segment 78 is about sixteen percent of tab 74. Of course, similar shape savings could result from the use of any material, whether metal or another. The calculated areas are intended to be representative only with respect to the illustrated configurations and are not a limitation, either as to possible savings or as to other possible configurations that would fall within the scope of the invention. With variations in tab shapes, the exact amount of savings might be more or less than the calculated savings of this specific example.

FIG. 10 shows the second basis for determining metal savings, which may be referred to as production savings. Tab blanks are formed from sheet stock 80, shown here for purposes of example only, as having the column height of three tabs. The tabs are blanked, stamped, cut, or otherwise formed from the sheet stock 80 in predetermined patterns, with the tabs located to efficiently utilize the available area of the sheet stock 80. In the drawing, tabs 10 are arranged in rows with the distal end of one tab nested in the proximal end of another. A grouping of nested tab blanks 10 is shown at the left hand side of FIG. 10. All tabs are shown in peripheral outline, only.

The nested pattern shows a clear example of good efficiency in utilizing the sheet stock. As each row is formed into a series of cut tab blanks 10, the row also generates scrap, such as at scrap areas 82 that are a part of no tab. Therefore, the efficiency of material usage can be derived by comparing the relative area of scrap 82 to the area of a produced tab blank 10. There is one scrap area 82 per tab blank 10, and this scrap area is about two percent of the area of a tab blank 10.

The middle grouping of tab blanks in FIG. 10 shows commercial tabs 74 in a row formation similar to the type of row formation for tabs 10 at the left of the drawing. A scrap area 84 is generated for each tab 74. Scrap area 84 is about eight and one half percent of the area of a commercial tab 74. Therefore, as an approximate comparison, the row arrangement for commercial tabs 74 generates about four times as much scrap as the row arrangement of nested tabs 10.

The row arrangement shown in the center of FIG. 10 may not be the most efficient arrangement for producing commercial tab blanks 74. It is possible that the distal end of a commercial blank 74 should be nested between the proximal ends of two tabs 74, in a staggered column arrangement best shown at the right hand grouping of FIG. 10. This nested, staggered arrangement produces two scrap areas 86, 88 that appear to total less than scrap area 84. The staggered commercial blanks 74 generate combined scrap areas 86, 88 that constitute about six percent of the tab 74 area. However, it cannot be concluded that the staggered column arrangement is more efficient than the row arrangement.

The staggered column configuration also generates an excess column end scrap 90. This excess column end scrap 90 is due to the inability of this arrangement to equally consume the sheet stock at the edges of alternate columns. The excess end scrap 90 can be estimated to be equal to one entire tab 74 plus one entire combined scrap area 86, 88. The eventual percent of scrap according to the right hand grouping of FIG. 8 can be calculated only with knowledge of the width of sheet stock 80 being employed and the number of tabs in each column. The three tab columns of FIG. 8 are merely for purposes of illustration. In a production setting, the sheet stock might be considerably wider and the number of tabs in each column might be considerably greater. Accordingly, the six percent scrap of combined areas 86, 88 is more of a minimum figure that might be increased by an undetermined amount.

By comparison, the blanks for tabs 10 are cut in rows with the nose of one tab nested near the concave edge of the next. This nested configuration produces substantially less scrap than either of the illustrated schemes for forming the commercial blanks 74. The scrap is about two percent of the area of blank 10. It may be projected that variations in tab shape could alter the percent of scrap for either the commercial tab 74 or the concave ended tab 10. However, the overall savings are likely to favor blanks 10, as suggested by comparison of the scrap percentage for either the straight and the staggered row arrangements for the commercial tab 74. The new concave ended tab 10 appears capable of production savings that can be estimated as sixty-six to seventy-five percent of the scrap produced in conventional commercial production. These savings can be equated to similar cost advantages. These prospective savings amounts are subject to variation according to changes and differences in production models versus those used in the foregoing example.

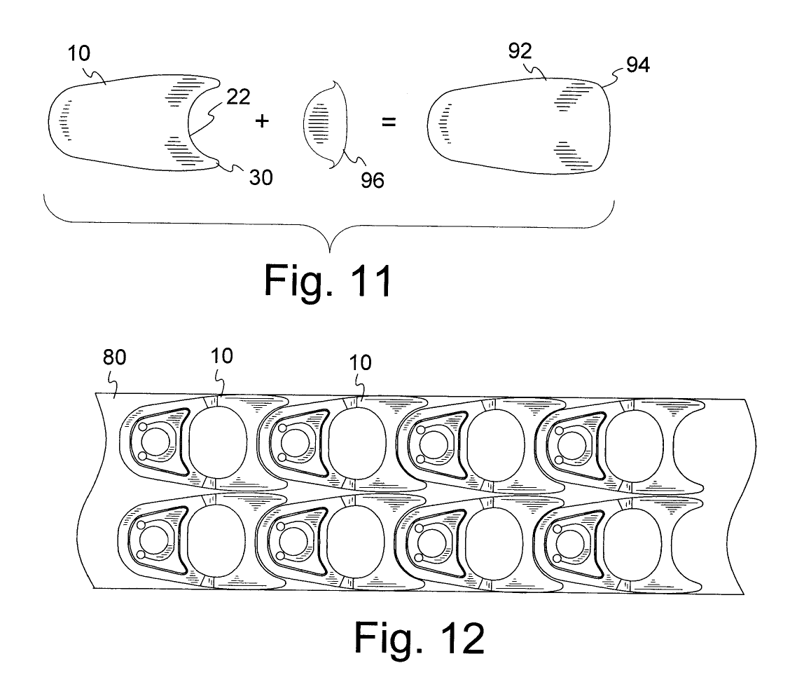

The comparison shown in FIG. 9 illustrates a beverage can style tab. The same tab can be increased in scale to form a food can style tab. However, some food can style tabs are tapered to employ a narrower nose and wider tail. For completeness, FIG. 11 compares such a tapered configuration. FIG. 11 shows an example of shape savings. The shape of tapered, food can style tab 10 is compared to the shape of a similar, conventional, commercial tab 92. As before, the two tabs are presented as blanks that show a peripheral outline without showing additional structures. Tabs 10 and 92 are presented as having the same tapering sides and similar total length. Where tab 10 is concave at edge 22, the corners 30 extend to a similar overall length as corners 94 of commercial tab 92.

A remainder segment 96 represents a shape savings, which is the difference in area between tabs 10 and 92. FIG. 11 again employs a formula presentation wherein the area of tab 10 plus the area of remainder segment 96 equals the area of tab blank 92. The calculated area of tab 10 in FIG. 10 is about eighty-three percent of the area of tab 92. Correspondingly, the shape savings represented by the area of remainder segment 96 is about seventeen percent of tab 92. Notably, the shape savings for the shape of tab 10 in FIG. 11 is only one percent from the shape savings for tab 10 in FIG. 9. This similarity of result shows that shape savings are similar even if other parts of the tab are varied within commercial practice.

FIG. 12 illustrates that the food can style of tab 10 enables production savings by efficiently utilizing the available area of the sheet stock 80. The food can style tabs can be blanked in the previously disclosed arrangement of rows with the distal end of one tab 10 nested in the proximal end of another tab 10. The nested pattern shows efficiency in utilizing the sheet stock, similar to the efficiency found in FIG. 8.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be regarded as falling within the scope of the invention as defined by the claims that follow.

What is claimed is:

1. A longitudinally disposed stay-on opening tab adapted for mounting on a container having an opening panel at least partially defined by a parting line, comprising:
a container opening nose at a distal end of said tab;
a lifting lever at a proximal end of the tab;
a fastener attachment structure intermediate said container opening nose and lifting lever;
wherein the lifting lever defines a proximal end edge of concave configuration; and
wherein said concave configuration is sized to at least partially receive a user's fingertip.

2. The longitudinally disposed stay-on opening tab of claim 1, wherein:
said opening nose is generally disposed along a first plane; and
said lifting lever comprises an upper wall portion lying at least partially along a second plane elevated from said first plane.

3. The longitudinally disposed stay-on opening tab of claim 1, wherein said lifting lever further comprises:
a lower wall portion lying approximately in said first plane; and
a dogleg wall interconnecting said lower wall portion and said upper wall portion, whereby said concavity is presented at an elevated position relative to said first plane.

4. The longitudinally disposed stay-on opening tab of claim 1, wherein:
said lifting lever is longitudinally arched, presenting said concavity with elevated central portion relative to said first plane.

5. The longitudinally disposed stay-on opening tab of claim 4, wherein:
said container opening nose is longitudinally arched, presenting the center of the nose in elevated position relative to said fastener attachment structure.

6. A container lid, comprising:
a lid body;
a parting line at least partially defining an openable panel in said lid body;
a fastener positioned on the lid body in predefined proximity to said openable panel for attaching a stay-on tab at a suitable location for selective operation to separate said parting line; and
a stay-on tab, comprising:
a container opening nose at a distal end of said tab;
a lifting lever at a proximal end of the tab; and
a fastener attachment structure intermediate said container opening nose end and lifting lever, attaching the stay-on tab to the lid body at a suitable location for selective operation to separate the parting line;
wherein the lifting lever defines a proximal end edge configured as a concavity sized to at least partially receive a user's fingertip.

7. The longitudinally disposed stay-on opening tab of claim 6, wherein:
said tab is longitudinally arched, presenting both the center of said nose and the center of said lifting lever in elevated position relative to said fastener attachment structure.

8. The container lid of claim 6, wherein:
said opening nose lies generally along a first plane; and
said lifting lever includes an upper wall portion lying at least partially along a second plane elevated from said first plane and defining said proximal end edge configured as a concavity.

9. The container lid of claim 6, wherein:
said opening nose lies generally along a first plane; and
said lifting lever is configured with a longitudinal arch that defines said proximal end edge as a compound concavity.

10. The container lid of claim 8, wherein said lifting lever further comprises:
a lower wall portion lying approximately in said first plane; and
a dogleg wall interconnecting said lower wall portion and said upper wall portion.

11. A container, comprising:
a container wall;
a parting line at least partially defining an openable panel in said container wall; and
a fastener positioned on the container wall in predefined proximity to said openable panel for attaching a stay-on tab in a suitable location for selective operation to separate said parting line;
wherein said stay-on tab comprises:
a distal end portion lying generally along a first plane near said container wall;
a proximal end portion defining a proximal end edge configured as a concavity sized to receive at least a portion of a user's fingertip therein; and
a fastener attachment structure engaged with said fastener and attaching said tab to the container wall in said predefined proximity to the openable panel for said selective operation to separate the parting line.

12. The container of claim 11, further comprising:
an elevation wall carrying at least a portion of said proximal end portion at a level elevated from said first plane and container wall and presenting said proximal end edge configured as a concavity at a separation from the container wall.

13. The container of claim 11, wherein:
said proximal end portion is configured in a longitudinal arch with the center of said arch spaced from said container wall by a greater dimension than the sides of the arch and presents said proximal end edge as a compound, longitudinally recessed concavity.

14. The container of claim 11, wherein:
both said proximal end portion and said nose are configured in a longitudinal arch with the center of said arch spaced from said container wall by a greater dimension than the sides of the arch; and
the longitudinal arch presents said proximal end edge as a compound, longitudinally recessed concavity.

15. A method of producing a longitudinally disposed stay-on opening tab having a container opening nose at a distal end of said tab and a lifting lever at a proximal end of the tab, wherein the lifting lever defines a proximal end edge configured as a concavity sized to at least partially receive a user's fingertip, comprising:
supplying sheet stock of material suitable for forming into said tabs;
forming the tabs from said sheet stock in a grouped row arrangement wherein said opening nose at a distal end of one tab is nested in said concavity of the proximal end of another tab.
